(19) United States
(12) Patent Application Publication
(10) Pub. No.: US 2024/0390788 A1
(43) Pub. Date: Nov. 28, 2024

(54) PROVIDING BIOFEEDBACK OF COMPUTER GAME PARTICIPANT TO SUSTAIN HEART RATE WITHIN LIMITS

(71) Applicant: Sony Interactive Entertainment LLC, San Mateo, CA (US)

(72) Inventor: Alex Benbassat, Los Angeles, CA (US)

(21) Appl. No.: 18/322,939

(22) Filed: May 24, 2023

(51) Int. Cl. A63F 13/40

(52) U.S. Cl. CPC A63F 13/40; A63F 2300/6054

(57) ABSTRACT

A biometric sensor such as a heart rate sensor sends signals representative of a video gamer's physical state, e.g., heart rate, to a computer game system, which can vary aspects of the game to maintain the heart rate of the gamer within limits.

### FIELD

The present application relates generally to techniques for providing biofeedback of computer game participants to sustain heart rates within limits.

### BACKGROUND

Computer games (also referred to herein as video games) are created by game developers with an eye toward maximizing player (gamer) enjoyment. As also understood herein, gamers may experience excessive ennui or excitement during play.

### SUMMARY

As understood herein, a target zone may be established for a gamer's heart rate and user interface and/or game modifications may be made to increase or decrease heartrate to sustain it within the target zone. For example, game music can be changed to keep the heart rate within the zone, difficulty level can be changed to keep the heart rate within the zone, game speed may be changed to keep the heart rate within the zone, lighting or brightness of the display can be changed to keep the heart rate within the zone, game border regions such as nature scenes with flowers can be changed to keep the heart rate within the zone, etc. Game music may be changed in response to the biometric feedback. As an example, more mellow music may be employed in scenes inducing higher pulse rates and more energetic music may be employed in scenes inducing lower pulse rates. Yet again, one or more sound effects (SFX) may be changed in response to the biometric feedback. As an example, louder SFX may be employed responsive to scenes inducing lower pulse rates and vice-versa. The tone of voice of one or more game characters may change in response to the biometric feedback. As an example, in scenes inducing higher pulse rates, a character's voice may be toned down.

Accordingly, a system includes at least one computer medium that is not a transitory signal and that in turn includes instructions executable by at least one processor assembly to receive indication from at least one sensor of heart rate of a player of a computer simulation, and responsive to the indication satisfying a test, alter an audio or video aspect of the computer simulation without changing action in the computer simulation or difficulty level of the computer simulation.

The test may include being out of a heart rate zone, and the instructions can be executable to, responsive to the indication satisfying the test, alter an audio aspect and/or a video aspect of the computer simulation without changing action or difficulty level of the computer simulation. For example, if the indication satisfies the test, the volume or type of a sound effect may be altered, or music of the simulation may be altered, or the voice of a character in the computer simulation may be altered. Further, if the indication satisfies the test, a brightness of the display on which the simulation s presented may be altered, or a background image in the simulation may be altered.

If desired, the test may include a first heart rate zone for a first scene of the computer simulation and a second heart rate zone for a second scene of the computer simulation.

In another aspect, a method includes receiving indication from at least one sensor of a physiological condition of a player of a computer simulation, and responsive to the indication satisfying a test, altering presentation of the computer simulation without changing action in the computer simulation or difficulty level of the computer simulation.

In another aspect, an apparatus includes at least one processor assembly programmed to receive indication of heart rate of at least one player of a computer simulation, determine if the heart rate is within a zone, and responsive to determining the heart rate is not within the zone, alter presentation of the computer simulation.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 illustrates an example specific system that may use components from FIG. 1;

FIG. 3 illustrates an example wristwatch-like device for holding a biometric sensor;

FIG. 4 illustrates an example finger ring for holding a biometric sensor;

FIG. 5 illustrates an example computer game controller for holding a biometric sensor;

FIG. 6 illustrates a gamer playing a video game;

FIG. 7 illustrates a gamer's heart rate over time on a graph showing upper and lower bounds of heart rate that can change from scene to scene in the game;

FIG. 8 illustrates example logic in example flow chart format consistent with present principles;

FIG. 9 illustrates a screen shot of a game consistent with FIG. 8;

FIG. 10 illustrates an example ML-based architecture; and

FIG. 11 illustrates example logic in example flow chart format for training the ML model shown in FIG. 10.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

A processor may be a single- or multi-chip processor that can execute logic by means of various lines such as address lines, data lines, and control lines and registers and shift registers. A processor assembly may include one or more processors acting independently or in concert with each other to execute an algorithm.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

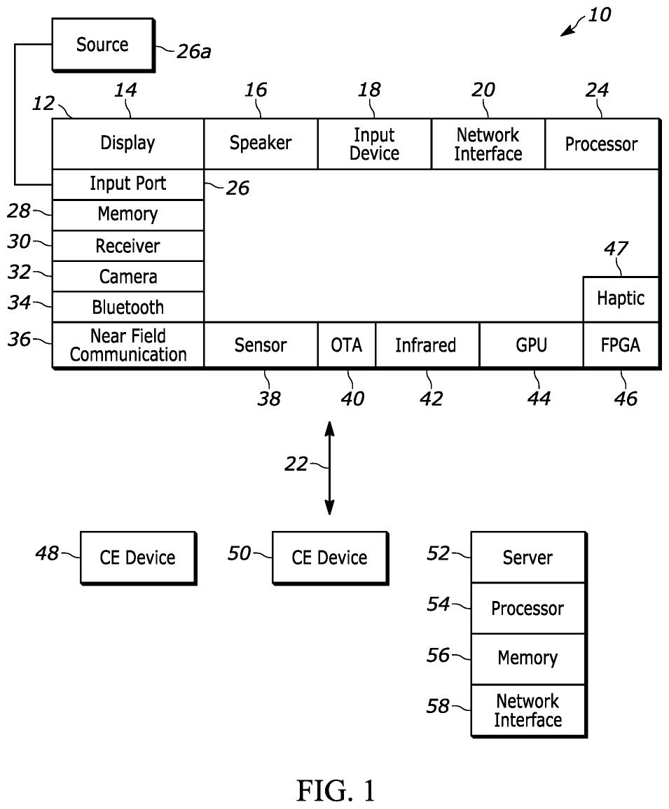

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command), providing input to the processor 24. The AVD 12 may include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics generators 47 may be provided for generating tactile signals that can be sensed by a person holding or in contact with the device.

Still referring to FIG. 1, in addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other devices of FIG. 1 over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown in FIG. 1 or nearby.

The components shown in the following figures may include some or all components shown in FIG. 1. The user interfaces (UI) described herein may be consolidated, expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. A network contemplated herein can include a large language model (LLM) such as a generative pre-trained transformer (GPTT).

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

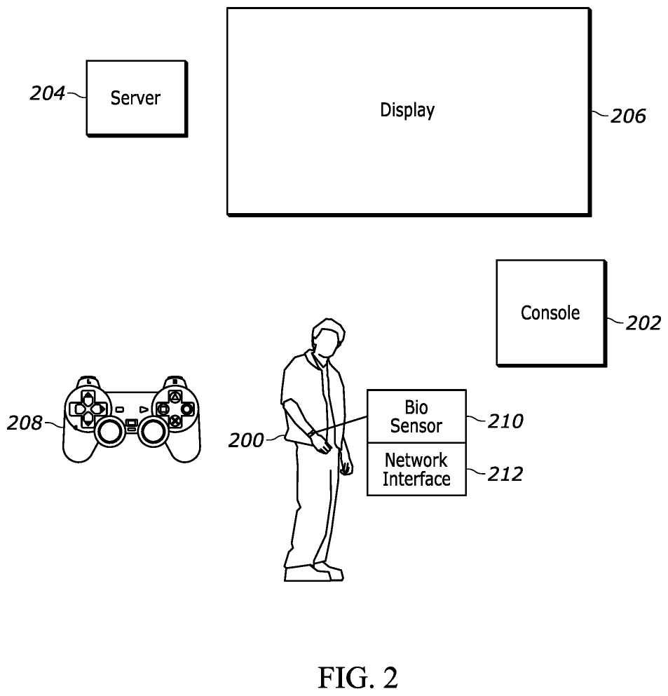

Turning to FIG. 2, a computer gamer or player 200 plays a computer game sourced from a computer game console 202 and/or one or more computer game servers 204 as presented on one or more displays 206 by operating one or more computer game controllers 208. One or more biometric sensors 210 may be engaged with the gamer 200 to provide biometric signals to the gaming system via one or more network interfaces 212 such as a wireless transceiver. The biometric signals represent a physical parameter or state of the gamer 200. The signals may be communicated to, e.g., the console 202 via Bluetooth, or the server 204 via Wi-Fi, or by other means.

Disclosure herein uses, as an example biometric sensor, a heart rate or pulse sensor. It is to be understood that other types of biometric sensors with supporting systems include iris sensors, voice sensors, face recognition systems, galvanic skin response (GSR) sensors, breath sensors including breath rate sensors, nanotechnology sensors, and other physiological sensors operating on chemical, electrochemical, optical, and electromagnetic bases.

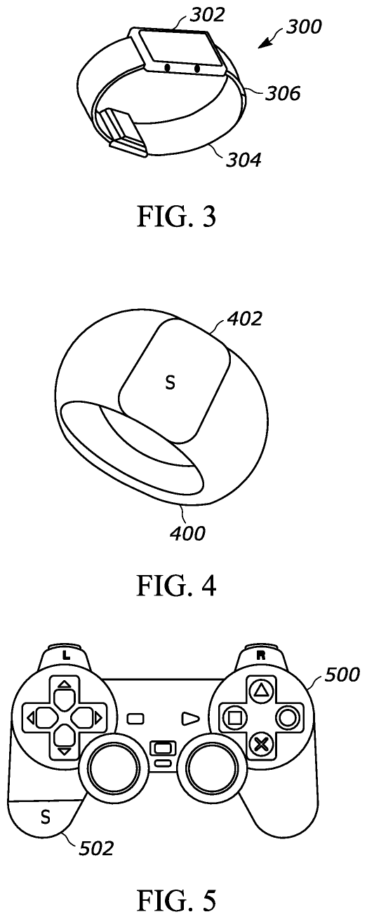

A biometric sensor according to present principles may be engaged with the gamer 200 by various means. In FIG. 3, for instance, a wristwatch-shaped device 300 with face 302 and wristband 304 holds one or more biometric sensors 306. In FIG. 4, a finger ring 400 holds one or more biometric sensors 402. In FIG. 5, a computer game controller 500 holds one or more biometric sensors 502.

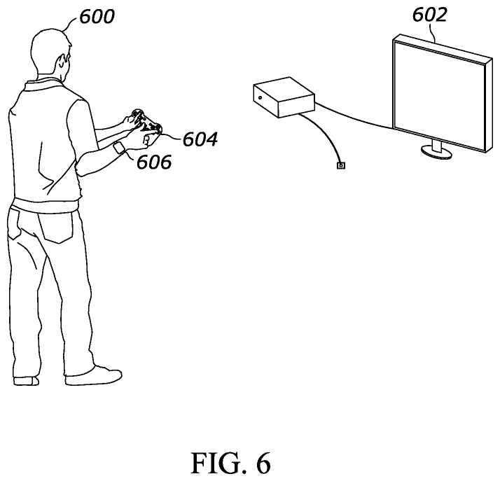

FIG. 6 illustrates a gamer 600 playing a video game/computer game being presented on a display 602 under control of a manipulable controller 604. A biometric sensor 606 such as a heart rate sensor is engaged with the gamer 600 via a wristwatch-like mount to measure the gamer's pulse, i.e., heart rate.

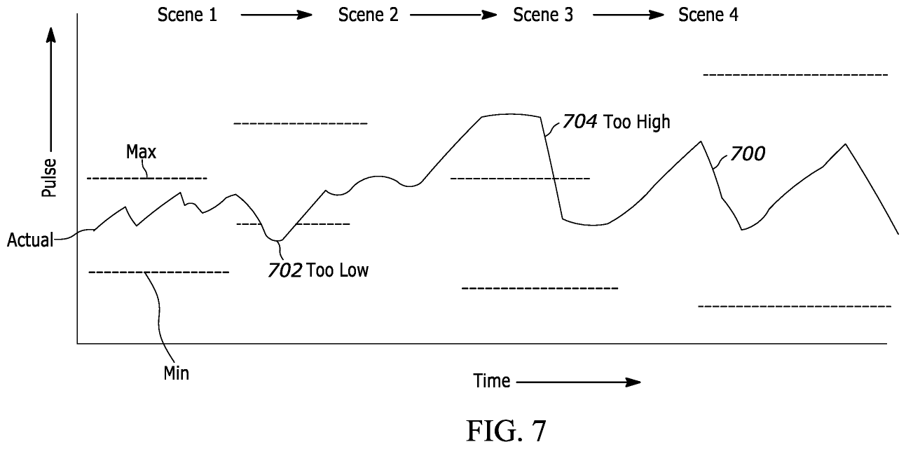

FIG. 7 illustrates a gamer's heart rate over time on a graph showing upper and lower bounds of heart rate that can change from scene to scene in the game. As shown, the bounds of an acceptable heart rate zone include a “max” bound and a “min” bound, shown as dotted lines in FIG. 7. The actual heart rate is shown as a solid line 700. If desired, the max and min bounds can change and the size of the zone can change from scene to scene. In FIG. 7, a first period 702 indicates a heart rate that is low out-of-zone while a second period 704 indicates a heart rate that is high out-of-zone. It is to be understood that the principles of FIGS. 7-11 apply to the use of other biometric sensors as well as pulse (heart rate) sensors.

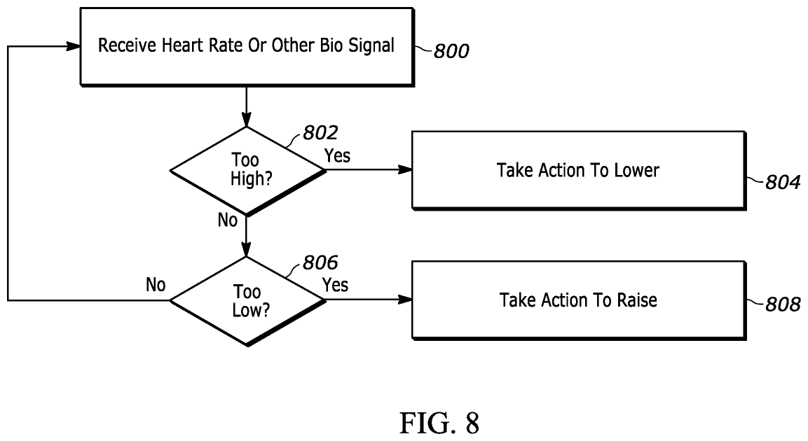

FIG. 8 illustrates example logic in example flow chart format. With FIG. 7 in mind, a signal is received at block 800 representing a physiological condition of a gamer, in an example, heart rate. If the signal indicates that the physiological condition is too high at state 802 (e.g., as it is in the period 704 in FIG. 7), the logic moves to state 804 to alter presentation of the computer simulation in a way that reduces the gamer condition, e.g., reduces heart rate. On the other hand, if the signal indicates that the physiological condition is too low at state 806 (e.g., as it is in the period 702 in FIG. 7), the logic moves to state 808 to alter presentation of the computer simulation in a way that reduces the gamer condition, e.g., increases heart rate.

Accordingly, a target zone may be established for a gamer's heart rate or other physiological condition and user interface and/or game modifications may be made to increase or decrease heartrate or other condition to sustain it within the target zone. For example, game difficulty level can be changed to keep the heart rate within the zone, or game speed may be changed to keep the heart rate within the zone.

However, in some embodiments an audio or video aspect of the computer simulation is changed to keep heart rate or other condition within a zone without changing the action or difficulty level of the computer simulation. For example, game music can be changed to keep the heart rate within the zone. As an example, more mellow music may be employed in scenes inducing higher pulse rates and more energetic music may be employed in scenes inducing lower pulse rates. Also, lighting or brightness of the display can be changed to keep the heart rate within the zone, game background regions such as nature scenes with flowers can be changed to keep the heart rate within the zone, etc. Yet again, one or more sound effects (SFX) may be changed in response to the biometric feedback. As an example, louder SFX may be employed responsive to scenes inducing lower pulse rates and vice-versa. The tone of voice of one or more game characters may change in response to the biometric feedback. As an example, in scenes inducing higher pulse rates, a character's voice may be toned down.

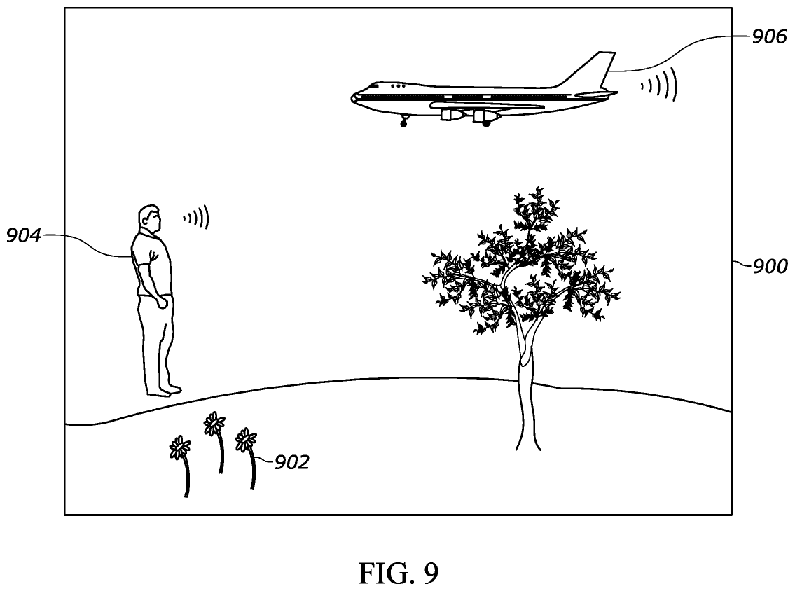

FIG. 9 illustrates a screen shot of a game presented on a display 900 consistent with FIG. 8. To keep heart rate or other condition within a zone, background images 902 such as flowers having no bearing on game play may be altered, e.g., more flowers might appear in response to high heart rate, or cooler colors may be used. The loudness of a voice of a character 904 may change responsive to the gamer's physiological condition without affected game play. The type and/or volume of sound effects such as the noise of a plane 906 may be altered responsive to the player's sensed physiological condition.

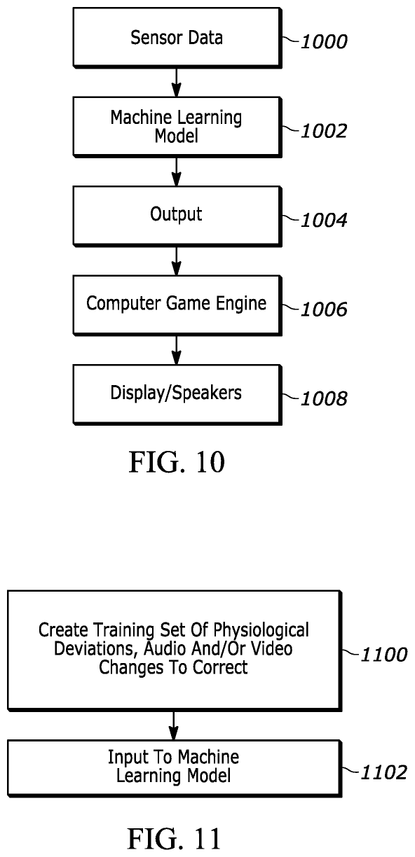

Machine learning (ML) may be used to determine actions to take in the event that a gamer's physiological condition as sensed by a sensor deviates from the established zone. Sensor data 1000 in FIG. 10 may be input to a ML model 1002, which generates an output 1004 indicating what alteration to game presentation should be made. The output 1004 is fed into the game engine 1006 sourcing the game being played by the gamer to alter presentation of the game on one or more displays/speakers 1008.

FIG. 11 illustrates that a training set of data may be created or assembled at block 1100. The training set includes sets of data, with each set including a physiological parameter deviation indicator (high or low) and associated changes in audio or video presentation of a computer game to counteract the deviations, as may be established by experts. The training data is input at block 1102 to the ML model 1002 to train the model. While the particular embodiments are herein shown and described in detail, it is to be understood that the subject matter which is encompassed by the present invention is limited only by the claims.

What is claimed is:

1. A system comprising:
at least one computer medium that is not a transitory signal and that comprises instructions executable by at least one processor assembly to:
receive indication from at least one sensor of heart rate of a player of a computer simulation; and
responsive to the indication satisfying a test, alter an audio or video aspect of the computer simulation without changing action in the computer simulation or difficulty level of the computer simulation.

2. The system of claim 1, wherein the computer simulation comprises a video game.

3. The system of claim 1, wherein the test comprises being out of a heart rate zone, and the instructions are executable to:
responsive to the indication satisfying the test, alter an audio aspect of the computer simulation without changing action or difficulty level of the computer simulation.

4. The system of claim 1, wherein the test comprises being out of a heart rate zone, and the instructions are executable to:
responsive to the indication satisfying the test, alter a video aspect of the computer simulation without changing action or difficulty level of the computer simulation.

5. The system of claim 1, wherein the test comprises a first heart rate zone for a first scene of the computer simulation and a second heart rate zone for a second scene of the computer simulation.

6. The system of claim 1, wherein the instructions are executable to:
responsive to the indication satisfying a test, alter a volume of a sound effect.

7. The system of claim 1, wherein the instructions are executable to:
responsive to the indication satisfying a test, replace a first sound effect with a second sound effect.

8. The system of claim 1, wherein the instructions are executable to:
responsive to the indication satisfying a test, alter a volume of a voice of a character in the computer simulation.

9. The system of claim 1, wherein the instructions are executable to:
responsive to the indication satisfying a test, alter a brightness of a display.

10. The system of claim 1, wherein the instructions are executable to:
responsive to the indication satisfying a test, alter a background image of the computer simulation.

11. The system of claim 1, wherein the instructions are executable to:
responsive to the indication satisfying a test, alter music of the computer simulation.

12. A method comprising:
receiving indication from at least one sensor of a physiological condition of a player of a computer simulation; and
responsive to the indication satisfying a test, altering presentation of the computer simulation without changing action in the computer simulation or difficulty level of the computer simulation.

13. The method of claim 12, wherein the sensor comprises a heart rate sensor and the test comprises being out of a heart rate zone.

14. The method of claim 12, comprising altering presentation of the computer simulation at least in part by altering audio of the computer simulation.

15. The method of claim 12, comprising altering presentation of the computer simulation at least in part by altering a brightness of a display on which the simulation is presented.

16. The method of claim 12, wherein the test comprises a first heart rate zone for a first scene of the computer simulation and a second heart rate zone for a second scene of the computer simulation.

17. An apparatus comprising:
at least one processor assembly programmed to:
receive indication of heart rate of at least one player of a computer simulation;
determine if the heart rate is within a zone; and
responsive to determining the heart rate is not within the zone, alter presentation of the computer simulation.

18. The apparatus of claim 17, wherein the processor assembly is programmed to:
test heart rate against a first zone for a first scene of the computer simulation; and
test heart rate against a second zone for a second scene of the computer simulation.

19. The apparatus of claim 17, wherein the processor assembly is programmed to, responsive to determining the heart rate is not within the zone, alter presentation of the computer simulation without changing action in the computer simulation or difficulty level of the computer simulation.

20. The apparatus of claim 17, wherein the processor assembly is programmed to alter presentation of the computer simulation responsive to determining the heart rate is not within the zone at least in part by altering music of the computer simulation.
